(19) United States
(12) Patent Application Publication
(10) Pub. No.: US 2026/0208067 A1
(43) Pub. Date: Jul. 23, 2026

(54) Self-Regenerating Atmospheric Water Generator for Low-Humidity Climates

(71) Applicant: Jameelah Salahuddin, Los Angeles, CA (US)

(72) Inventor: Jameelah Salahuddin, Los Angeles, CA (US)

(21) Appl. No.: 19/017,660

(22) Filed: Jan. 12, 2025

(51) Int. Cl. B01D 5/00

(52) U.S. Cl. CPC B01D 5/0003; B01D 5/0072; B01D 5/009; B01D 2221/16; B01D 2253/112; B01D 2257/80

(57) ABSTRACT

The present invention relates to a self-regenerating atmospheric water generator (AWG) for producing potable water from ambient air in moderate-to-low humidity conditions. The AWG includes a coated desiccant wheel, embedded with gypsum fibers, for enhanced moisture adsorption and desorption. The system comprises an air-intake chamber with an air-intake fan, a desorption chamber for initiating the desorption process, and a condenser to cool the air and condense water vapor. Collected water is filtered through membrane filters and purified using a UV light system to ensure its quality. This compact and energy-efficient AWG system provides a sustainable source of clean water by leveraging environmental conditions and an innovative desiccant wheel design.

### FIELD

This disclosure relates to atmospheric water generators and in particular to self-regenerating atmospheric water generators.

### BACKGROUND

Atmospheric Water Generators (AWGs) represent a promising technology for addressing the growing global demand for clean and accessible drinking water. Traditional AWGs have relied heavily on energy-intensive methods often requiring external heat sources or complex heat exchangers for the water generation process.

One of the primary challenges in AWG technology has been achieving energy efficiency and self-sustainability, especially in low-humidity environments where water resources are most urgently needed. Moreover, traditional AWGs have struggled to adapt to varying environmental conditions and often face limitations in terms of scalability and practicality.

In recognition of these challenges, there is a pressing need for innovations that can make AWGs more energy-efficient, self-regenerating, and adaptable to a wide range of environmental conditions. This US Patent Application introduces an AWG system that overcomes the limitations of traditional technology.

### SUMMARY

The present invention relates to an Atmospheric Water Generator (AWG) that boasts a pioneering self-regenerating design eliminating the need for energy-intensive heat exchangers or external heat sources.

The Self-Regenerating Atmospheric Water Generator utilizes a desiccant wheel coated with a uniform layer of gypsum widely known for its high affinity for water molecules, or a similar substance and material with comparable properties.

Absorption Phase: During the absorption phase, the desiccant wheel rotates within the absorption chamber encountering ambient air drawn in by an intake fan.

Desorption Phase: After absorbing moisture, the desiccant wheel advances to the desorption chamber where the self-regenerating desorption process begins.

The released water is efficiently collected and filtered through a Polypropylene Filter Membrane situated at the base of the filtration pan.

### DETAILED DESCRIPTION

The following detailed description provides an in-depth explanation of the Self-Regenerating Atmospheric Water Generator (AWG) including its operation during the absorption and desorption phases for cultivating potable water, as illustrated in FIG. 13. The system is designed to efficiently extract water from the atmosphere using a chemically coated desiccant wheel (34), as shown in FIG. 6, that regenerates itself through cyclical phases driven by changes in humidity.

### Absorption Phase

The AWG begins its operation with the absorption phase, where the desiccant wheel (34), as shown in FIG. 6, is coated with a layer of Calcium Sulfate Hemihydrate or another highly absorbent substance that exhibits a strong affinity for water molecules. The desiccant wheel (34) is positioned within the air-intake chamber (102), as shown in FIG. 5, where an air-intake fan (44), as shown in FIG. 1, draws in ambient air containing water vapor while the desiccant wheel is rotated by the Wheel Rotation and Transfer Arm (18), as shown in FIG. 11.

As the desiccant wheel (34) is rotated by the motorized arm (18), within the air-intake chamber (102), as shown in FIG. 6, it comes into contact with the moist air. The Calcium Sulfate Hemihydrate or similar substance on the surface of the desiccant wheel (34) absorbs the water vapor from the air, undergoing a physical phase change to form Calcium Sulfate Dihydrate (CaSO₄·2H₂O), also known as gypsum or a substance with similar properties and functionality. In this process, water molecules become trapped within the crystal lattice of the gypsum or a substance with similar properties and functionality, effectively storing moisture from the air.

This chemical absorption process is both efficient and effective in capturing water vapor, even in low-humidity environments, due to the strong hydrophilic nature of Calcium Sulfate Hemihydrate or a similar or modified substance with a high affinity for water. The physical interaction between the desiccant material (34) and water vapor is key to the invention's functionality in absorbing atmospheric moisture.

### Desorption Phase

As the desiccant wheel (34), as shown in FIG. 7, continues to rotate, the Wheel Rotation and Transfer Arm (18) then moves it into the desorption chamber (100), as shown in FIG. 7, which is hermetically sealed to control the internal environment. Within the desorption chamber (100), the condenser (16), as shown in FIG. 7, is activated, initiating the desorption process.

The desorption process begins when the temperature inside the desorption chamber (100) is lowered to the dew point, causing the humidity within the desorption chamber (100) to drop significantly. This change in humidity triggers a chemical reaction within the desiccant wheel (34), as shown in FIG. 8. The chemical begins to release the bound water molecules, undergoing a phase change that reverts the gypsum back into Calcium Sulfate Hemihydrate or similar absorbent material, thus regenerating the desiccant material (34) naturally.

### Water Purification and Collection

The release of the absorbed water vapor during desorption is a key feature of the system's self-regenerating design. The released water vapor is collected and condensed into liquid water by the condenser (16), as shown in FIG. 7, which channels the water into the first collection system that includes the filtration pan (36), as shown in FIG. 7, which houses a Polypropylene Filter Membrane (60), as shown in FIG. 8. The water then passes through a second purification system into the Water Take Inlay (50), as illustrated in FIG. 14, before being filtered through a Polyethersulfone Filter Membrane (14), positioned at the bottom of the Water Tank Inlay (50), as shown in FIG. 14.

The water then flows through the Waterspout (56), as illustrated in FIG. 11, after passing a UV Light System (17), also illustrated in FIG. 11, completing the final purification stages.

The condensation of water vapor into liquid water is a critical step in making the water available for use or storage. The hydration-dehydration cycle of the desiccant wheel (34), as illustrated in FIG. 6 and FIG. 7, is driven by changes in humidity, without significant changes in temperature. This allows the system to operate efficiently and continuously without the need for energy-intensive heating elements, as is the case in many traditional atmospheric water generation systems.

### Reversibility and Self-Regeneration

The use of Calcium Sulfate Hemihydrate or a similar chemical with analogous properties provides the system with its self-regenerating capability. The desorption phase naturally reverses the hydration that occurs during the absorption phase, restoring the desiccant material to its original state without the need for external energy inputs beyond humidity control.

This reversible chemical process can be cycled multiple times without degrading the effectiveness of the desiccant wheel (34). The ability to alternate between absorbing and releasing water vapor based solely on changes in humidity makes the system self-sustaining and energy-efficient.

By utilizing the natural humidity fluctuations in the surrounding air, the system does not require external heat sources or complex mechanical systems to regenerate the desiccant material. This property allows the desiccant material to regenerate itself in situ, resulting in a low-maintenance and energy-efficient design.

### System Components and Operation

The key components of the Self-Regenerating Atmospheric Water Generator include:
1. Desiccant Wheel (34): Coated with Calcium Sulfate Hemihydrate or a similar absorbent chemical, the wheel rotates between the absorption and desorption chambers.
2. Air-Intake Chamber (102): The chamber where ambient air is drawn in by the intake fan (44), exposing the desiccant wheel (34) to moist air.
3. Wheel Rotation and Transfer Arm (18): The motorized arm that both rotates and moves the desiccant wheel (34) in between the air-intake chamber (102) and the desorption chamber (100).
4. Desorption Chamber (100): A hermetically sealed chamber where the condenser (16) lowers the temperature to the dew point, triggering the release of water vapor from the desiccant wheel (34).
5. Wheel Rotation and Transfer Arm (18):
6. Condenser (16): Responsible for cooling the air within the desorption chamber (100) and causing the condensation of the released water vapor.
7. Water Collection System: Channels the condensed water into the Filtration Pan (36) that houses the Polypropylene Filter Membrane (60), a collection tank for storage or use.

In one embodiment, the desiccant wheel is coated with gypsum fibers to enhance its water-absorbing capabilities; however, other absorbent materials with similar properties may also be utilized. The absorption and desorption chambers are integrated into a single housing, creating a compact and efficient design that can be easily scalable for various environments and applications.

Additionally, the system may include a filtering mechanism within the water channels to ensure that the collected water is clean and safe for consumption, making this technology suitable for a wide range of applications where access to clean water is limited.

### BRIEF DESCRIPTION OF THE DRAWINGS

The drawings described herein are for illustration purposes only and are not intended to limit the scope of this disclosure in any way.

FIG. 1 depicts a front view of the atmospheric water generator system, illustrating the Air-Intake Chamber (30), Intake Fan (44), Collection Tank (54), UV Light System (17), and Waterspout (56).

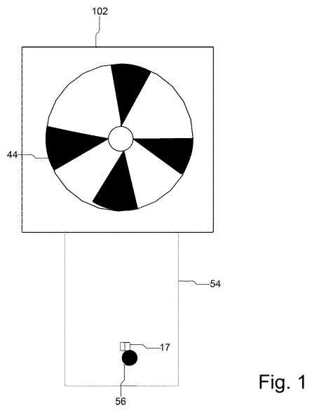

FIG. 2 depicts a rear view of the atmospheric water generator system, showing the Desorption Chamber (100) and Collection Tank (54).

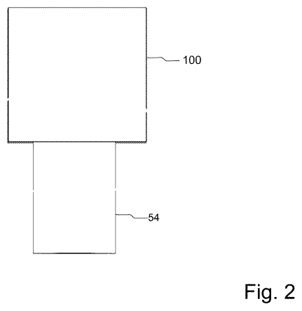

FIG. 3 depicts a top view of the atmospheric water generator system, highlighting the Desorption Chamber (100), Air-Intake Chamber (102), and Intake Fan (44).

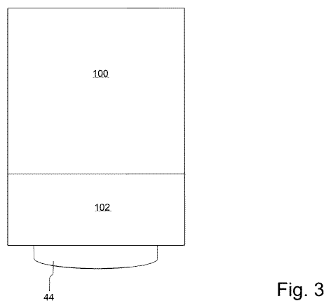

FIG. 4 depicts a bottom view of the atmospheric water generator system, illustrating the Air-Intake Chamber (30), Intake Fan (44), Collection Tank (54), Water Tank Spout (56), and Desorption Chamber (100).

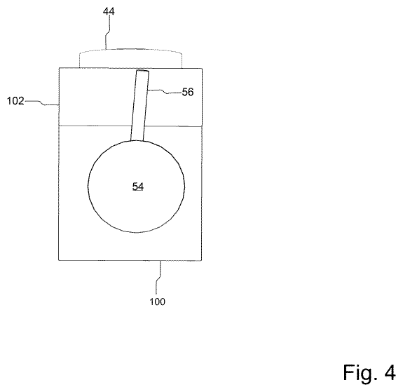

FIG. 5 depicts a side view of the atmospheric water generator system, showing the AWG Unit (10), Desorption Chamber (100), Air-Intake Chamber (102), Intake Fan (44), Collection Tank (54), UV Light System (17), and Waterspout (56).

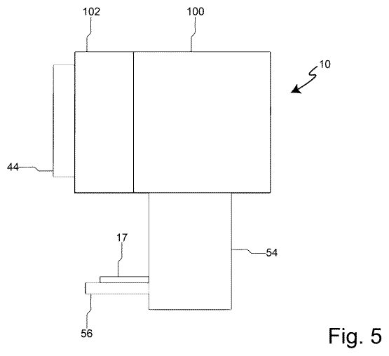

FIG. 6 depicts a top perspective view of the Air-Intake Chamber (30), featuring the Condenser (16), Air-Intake Chamber (102), Intake Fan (44), Coated Desiccant Wheel (34), Wheel Rotation and Transfer Arm (18), Desorption Chamber (100), Filtration Pan (36), Polypropylene Filter Membrane (60), Water Tank Inlay (50), Polyethersulfone Filter Membrane (14), Collection Tank (54), UV Light System (17), and Waterspout (56).

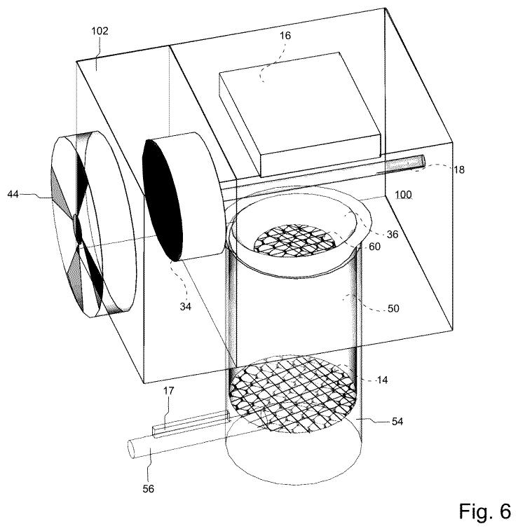

FIG. 7 depicts a perspective view of the atmospheric water generator system, including the AWG Unit (10), Condenser (16), Air-Intake Chamber (102), Intake Fan (44), Desiccant Wheel coated with Calcium Sulfate Hemihydrate or similar material (34), Wheel Rotation and Transfer Arm (18), Desorption Chamber (100), Filtration Pan (36), Polypropylene Filter Membrane (60), Water Tank Inlay (50), Polyethersulfone Filter Membrane (14), Collection Tank (54), UV Light System (17), and Waterspout (56).

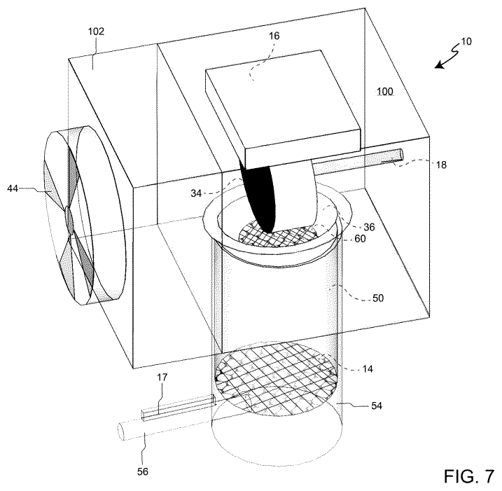

FIG. 8 depicts an isolated schematic view of internal components, illustrating the Coated Desiccant Wheel (34), Intake Fan (44), Wheel Rotation and Transfer Arm (18), Filtration Pan (36), Polypropylene Filter Membrane (60), Water Tank Inlay (50), Polyethersulfone Filter Membrane (14), Collection Tank (54), UV Light System (17), and Waterspout (56).

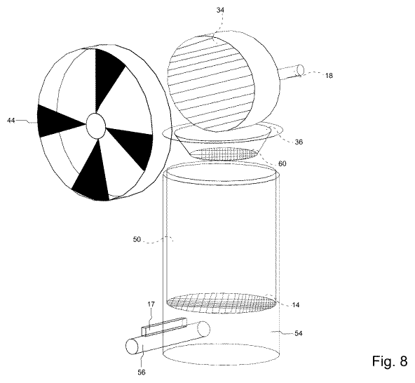

FIG. 9 depicts a schematic view of the absorption chamber components, featuring the Condenser (16), Air-Intake Chamber (102), Intake Fan (44), Coated Desiccant Wheel (34), Wheel Rotation and Transfer Arm (18), Filtration Pan (36), Water Tank Inlay (50), Collection Tank (54), UV Light System (17), and Waterspout (56).

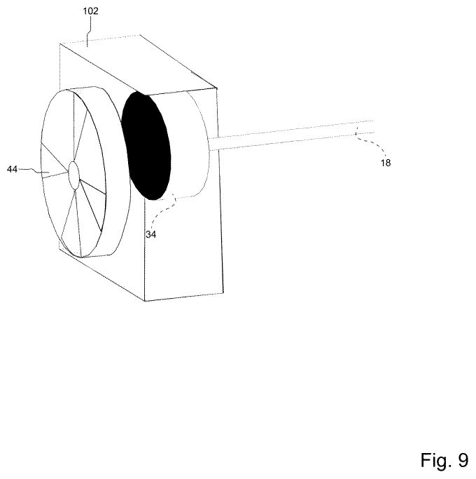

FIG. 10 depicts an exploded axonometric view of the system, showing the Condenser (16), Intake Fan (44), Coated Desiccant Wheel (34), Wheel Rotation and Transfer Arm (18), Desorption Chamber (100), Filtration Pan (36), Water Tank Inlay (50), Collection Tank (54), UV Light System (17), and Waterspout (56).

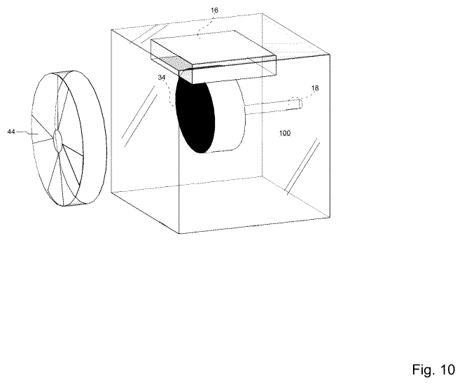

FIG. 11 depicts an exploded axonometric view of the desorption process, illustrating the Condenser (16), Intake Fan (44), Coated Desiccant Wheel (34), Wheel Rotation and Transfer Arm (18), Filtration Pan (36), Water Tank Inlay (50), Collection Tank (54), UV Light System (17), and Waterspout (56).

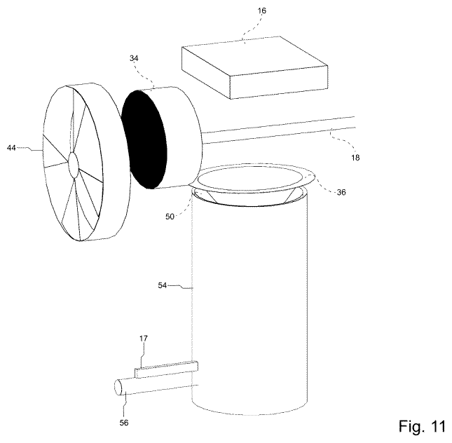

FIG. 12 depicts an exploded axonometric view of the final purification stage, showing the Condenser (16), Intake Fan (44), Coated Desiccant Wheel (34), Wheel Rotation and Transfer Arm (18), Filtration Pan (36), Water Tank Inlay (50), Collection Tank (54), UV Light System (17), and Waterspout (56).

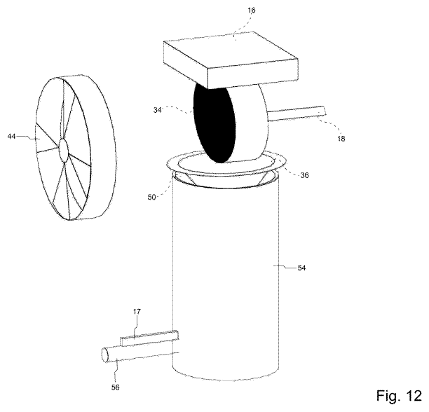

FIG. 13 depicts a schematic system view of the atmospheric water generator, illustrating the Intake Fan (44), the Calcium Sulfate Hemihydrate-Coated Desiccant Wheel (34), the Wheel Rotation and Transfer Arm (18), the Desorption Chamber (100), the Filtration Pan (36), the Polypropylene Filter Membrane (60), the Polyethersulfone Filter Membrane (14), the Collection Tank (54), the UV Light System (17), and the Waterspout (56).

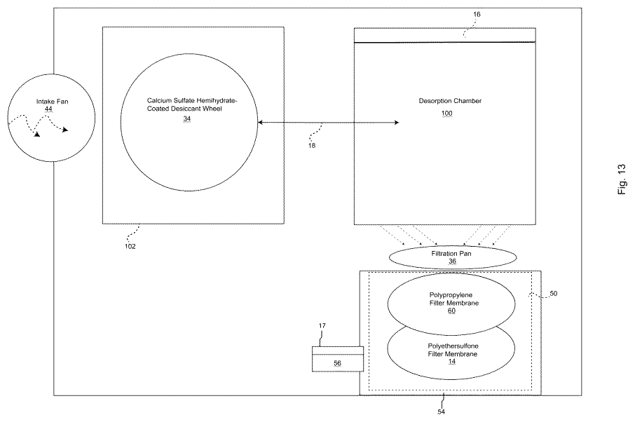

FIG. 14 depicts a sectional perspective view of the atmospheric water generator system, showing the Condenser (16), Intake Fan (44), the Desorption Chamber (100), the Air-Intake Chamber (102), the Desiccant Wheel (34), the Wheel Rotation and Transfer Arm (18), the Filtration Pan (36), the Polypropylene Filter Membrane (60), the Water Tank Inlay (50), the Polyethersulfone Filter Membrane (14), the Collection Tank (54), the UV Light System (17), and the Waterspout (56).

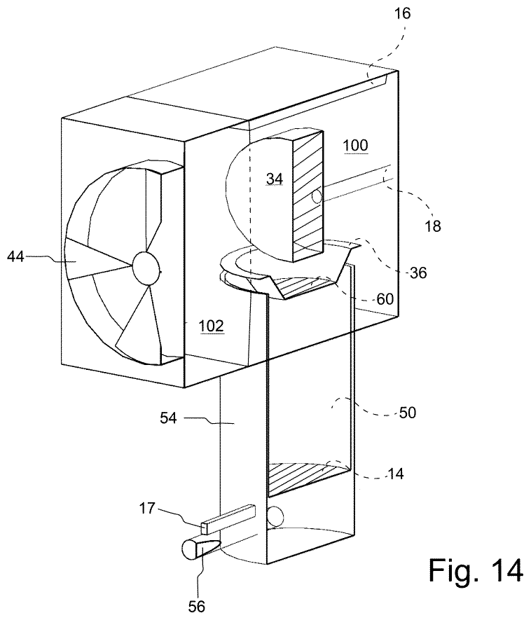

1. A self-regenerating atmospheric water generator comprising:
(a) a coated desiccant wheel configured to adsorb moisture from ambient air;
(b) an absorption chamber configured to expose the coated desiccant wheel to ambient air;
(c) a desorption chamber;
(d) a transfer mechanism configured to move the coated desiccant wheel from the absorption chamber to the desorption chamber;
(e) a condenser associated with the desorption chamber and configured to cool the desorption chamber to promote release of adsorbed moisture from the coated desiccant wheel and condense the released moisture; and
(f) a collection system configured to receive the condensed moisture as liquid water.

2. The atmospheric water generator of claim 1, wherein the coated desiccant wheel comprises a wheel having a hygroscopic desiccant material thereon.

3. The atmospheric water generator of claim 2, wherein the hygroscopic desiccant material comprises calcium sulfate hemihydrate.

4. The atmospheric water generator of claim 1, wherein the transfer mechanism comprises a rotation and transfer arm configured to rotate and move the coated desiccant wheel.

5. The atmospheric water generator of claim 1, wherein the desorption chamber is sealable during release of the adsorbed moisture.

6. The atmospheric water generator of claim 1, wherein the collection system comprises at least one filter membrane.

7. The atmospheric water generator of claim 6, wherein the collection system comprises a first filter membrane and a second filter membrane.

8. The atmospheric water generator of claim 1, further comprising an ultraviolet purification system configured to treat the liquid water.

9. A method of generating water from ambient air, comprising:
(a) exposing a coated desiccant wheel to ambient air in an absorption chamber such that moisture from the ambient air is adsorbed onto the coated desiccant wheel;
(b) transferring the coated desiccant wheel from the absorption chamber to a desorption chamber;
(c) operating a condenser associated with the desorption chamber to cool the desorption chamber and promote release of the adsorbed moisture from the coated desiccant wheel;
(d) condensing the released moisture into liquid water; and
(e) collecting the liquid water.

10. The method of claim 9, wherein transferring the coated desiccant wheel comprises rotating and moving the coated desiccant wheel with a transfer arm.

11. The method of claim 9, wherein the coated desiccant wheel comprises a wheel having a hygroscopic desiccant material thereon.

12. The method of claim 11, wherein the hygroscopic desiccant material comprises calcium sulfate hemihydrate.

13. The method of claim 9, wherein collecting the liquid water comprises passing the liquid water through at least one filter membrane.

14. The method of claim 13, further comprising exposing the liquid water to ultraviolet purification.

15. The method of claim 9, wherein the desorption chamber is sealed during release of the adsorbed moisture.
